(19) United States
(12) Patent Application Publication
(10) Pub. No.: US 2004/0182658 A1
(43) Pub. Date: Sep. 23, 2004

(54) Pressure relief arrangement for a disc brake system

(76) Inventor: James J. Dimsey, Brookfield, WI (US)

Correspondence Address: WHYTE HIRSCHBOECK DUDEK S C, 555 EAST WELLS STREET, SUITE 1900, MILWAUKEE, WI, 53202, US

(21) Appl. No.: 10/789,621

(22) Filed: Feb. 27, 2004

Related U.S. Application Data
(60) Provisional application No. 60/450,477, filed on Feb. 27, 2003.

(51) Int. Cl. B60T 13/22

(52) U.S. Cl. 188/72.4

(57) ABSTRACT

A pressure relief arrangement for a disc-type brake system in which a master cylinder assembly applies and releases the brake. The pressure relief arrangement is in the form of a pressure relief valve located between the piston and reservoir of the master cylinder assembly. The pressure relief valve provides normal operation of the brake upon extension and retraction of the piston when fluid pressure remains below a predetermined threshold. When fluid pressure exceeds the predetermined threshold, the pressure relief valve establishes communication between the reservoir and the fluid flow path, to relieve the excessive pressure. In this manner, the pressure relief valve reduces or eliminates the brake calipers from functioning improperly when the brakes are applied, which can result from the excess pressure caused by fluid expansion and dynamic braking effects that tend to move the caliper pistons.

### CROSS-REFERENCE TO RELATED APPLICATIONS

This application claims the benefit of U.S. provisional application serial No. 60/450,477, filed Feb. 27, 2003, the disclosures and teachings of which are herein incorporated by reference.

### BACKGROUND AND SUMMARY OF THE INVENTION

This invention relates to a brake system, and more particularly to an arrangement for preventing adverse effects which can occur when the brake system experiences excessive fluid pressure.

Brake systems, as hydraulic systems, rely significantly on precise pressures that translate into precise movements of the components parts. This is particularly significant in the precise caliper piston movements required in disc brake systems. The thermal expansion of fluid in the system or from contact between the brake disc and the brake pads may translate into knock-back of the brake actuating piston.

A disc brake system typically includes a master cylinder assembly which is responsive to an operator-controlled lever or pedal to control operation of a caliper, and thereby application and release of the brake. The master cylinder assembly includes a body defining a fluid reservoir, and a piston mounted within the master cylinder body. The piston is movable relative to the master cylinder body between an extended position and a retracted position. Typically, the master cylinder piston is moved to the extended position in response to actuation of the brake lever or pedal by an operator. Such extension of the piston is operable to displace a quantity of fluid from the master cylinder which causes movement of the caliper so as to apply the brake. When the operator releases the brake pedal or lever, the piston is moved to the retracted position under the influence of a spring. The piston includes a seal arrangement, and is exposed to fluid within the valve body. The seal arrangement is configured to cut off communication between the interior of the valve body and the fluid reservoir when the piston is moved to the extended position, and to establish communication between the reservoir and the interior of the valve body when the piston is moved to the retracted position. In this manner, the quantity of fluid that is displaced upon extension of the piston returns to the reservoir through the interior of the valve body when the piston is retracted.

One problem is known as “knock-back”, in which the dynamic effects of a vehicle can tend to push the caliper pistons into their respective bores forcing fluid into the master cylinder reservoir. In most instances, this results in partial or complete loss of braking capability. The loss of fluid in the pressure circuit causes increased lever/pedal movement and in effect decreases the ability to achieve system pressure. Another result of knockback is an unnatural braking sensitivity, in which this increased lever/pedal travel reduces the ability to modulate braking power.

In general, brake calipers that are hard mounted to a vehicle versus floating automotive type calipers experience this knock-back. More specifically, this occurs when caliper pistons are pushed into their respective bores due to the dynamic effects of a vehicle. When enough fluid is displaced to the master cylinder reservoir during this event, the brake lever/pedal can be completely actuate with little or no braking of vehicle.

Under certain circumstances, an increase in pressure in the fluid flow path can result in undesirable effects on the brake system. For example, when the disc comes into contact with the brake pads, which is caused by an increase in pressure from thermal expansion of a fluid in the brake line, it tends to move the piston inwardly beyond its normal retracted position. This condition is commonly known as thermal lock, and creates the potential for the caliper piston to be moved such that premature braking can occur without actuation of the brake lever/pedal. In addition, thermal expansion of the brake fluid may cause extension of the piston even when the brake is not applied, resulting in drag on the brake disc.

It is an object of the present invention to provide a pressure relief arrangement for a disc brake system, which prevents the adverse effects that can result from excessive pressure in the brake system caused by contact between the brake disc and the brake pads or thermal expansion of brake fluid in the system. It is a further object of the invention to provide such a pressure relief arrangement which is incorporated in the master cylinder body. A further object of the invention is to provide such a pressure relief arrangement that controls the flow of fluid between the fluid flow path and the fluid reservoir upon movement of the piston between the extended and retracted positions.

A still further object of the invention is to provide such a pressure relief arrangement which functions as a valve that selectively establishes communication between the valve interior and the fluid reservoir when pressure in the fluid flow path exceeds a predetermined threshold. Yet another object of the invention is to provide such a pressure relief arrangement which allows the brake to be operated in the same manner as in the prior art while preventing the adverse effects that can occur from excessive pressure in the system. A still further object of the invention is to provide such a pressure relief arrangement which is relatively simple in its components, construction and operation, yet which is effective to control the flow of fluid between the valve interior and the fluid reservoir while preventing the adverse effects that can occur from excessive pressure in the valve interior.

In accordance with one aspect of the present invention, a disc brake system includes a brake disc and a caliper, and an actuator for selectively moving the caliper to apply and release the brake. The brake actuator includes a master cylinder body defining a fluid reservoir, and a valve body mounted within a passage defined by the master cylinder body. A piston is mounted for movement between an extended position and a retracted position. In a typical configuration, movement of the piston to the extended position displaces a quantity of fluid from the interior to operate the caliper so as to apply the brake, and movement of the piston toward the retracted position returns a quantity of fluid toward the fluid reservoir through the interior, to release the brake. A pressure relief valve arrangement is interposed between the interior and the reservoir, for controlling the flow of fluid upon movement of the piston between the extended and retracted positions. The pressure relief valve arrangement is configured and arranged to selectively vent fluid from the to the fluid reservoir in the event pressure in the fluid flow path exceeds a predetermined threshold. In the disclosed embodiment, the pressure relief valve arrangement includes a valve body defining an internal cavity in communication with the interior, and the valve body includes a relief port in communication with the fluid reservoir. The pressure relief valve arrangement further includes a biased valve member movably mounted with the internal cavity, which normally seals the relief port to prevent communication between the internal cavity and the reservoir. During normal operation, brake release causes the piston to move from the extended position to the retracted position to return fluid to the interior, which causes fluid to be displaced into the internal cavity and results in movement of the valve member to move to an expanded position against the bias. When the brake is applied, the piston is moved toward the extended position to displace fluid from the interior, and the valve member is opened to the reservoir and is moved to an exhaust position under the influence of the bias to discharge fluid from the internal cavity into the fluid reservoir through a series of ports associated with the master cylinder body. The valve body is configured such that the valve member normally prevents communication between the internal cavity and the fluid reservoir through the relief port when the valve member is in both the expanded position and the exhaust position. The valve member is further movable from the expanded position to a relief position against the bias when pressure in the fluid flow path exceeds the predetermined threshold. When in the relief position, the valve member is positioned such that the relief port is opened so as to establish communication between the internal cavity and the fluid reservoir. This functions to relieve pressure in the internal cavity and thereby in the interior, to prevent movement of the piston beyond its normal retracted position in the event of contact between the brake disc and the brake pads which otherwise may result in knock-back of the piston, and to prevent piston extension which may otherwise result from thermal expansion of fluid in the system.

The invention contemplates a brake actuator or master cylinder assembly incorporating a pressure relief arrangement, as well as a method of relieving excessive pressure in a brake system, substantially in accordance with the foregoing summary.

### BRIEF DESCRIPTION OF THE DRAWINGS

A preferred exemplary embodiment of the invention is illustrated in the accompanying drawings in which like reference numerals represent like parts throughout, and in which:

FIG. 1 is a sectional view schematically illustrating a brake system that includes a master cylinder assembly incorporating the pressure relief valve arrangement of the present invention, in which the piston of the master cylinder assembly is shown in a retracted position and the valve member of the pressure relief valve arrangement is shown in an expanded position;

FIG. 1A is an exploded view of the pressure relief valve arrangement in accordance with one aspect of the present invention;

FIG. 2 is a sectional view showing the master cylinder assembly as in FIG. 1, in which the piston of the master cylinder assembly is shown in an extended position for applying the brake and the valve member of the pressure relief valve arrangement is shown in an at rest position; and

FIG. 3 is a sectional view similar to FIG. 2, showing the piston in the retracted position and the valve member of the pressure relief arrangement moved to a relief position for relieving excessive pressure in the master cylinder assembly.

### DETAILED DESCRIPTION OF THE INVENTION

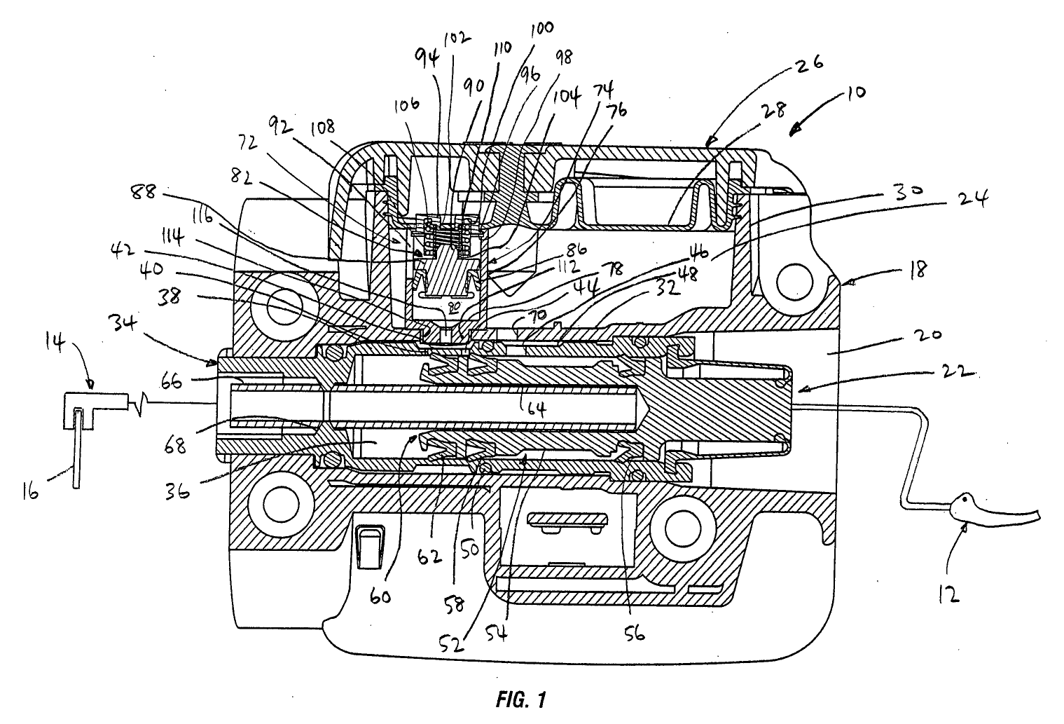

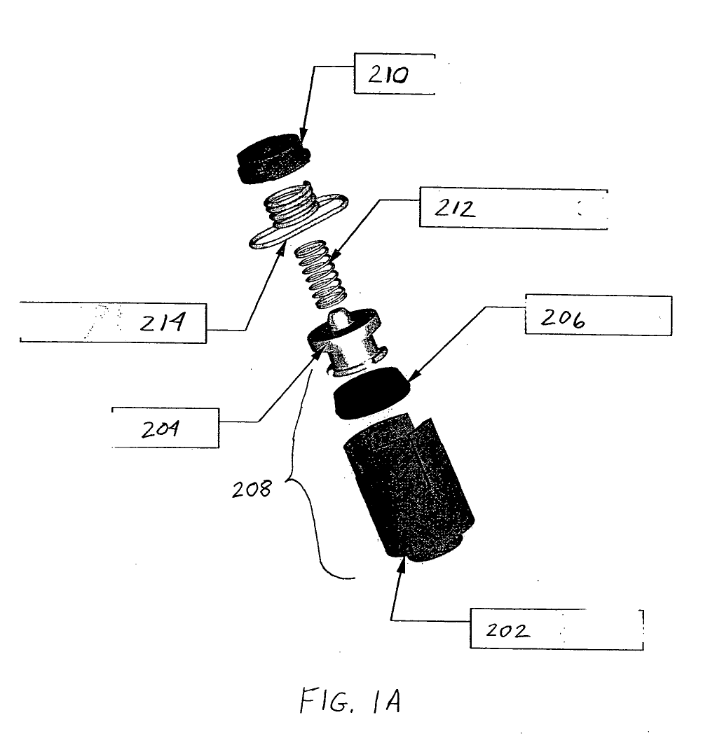

FIG. 1 schematically illustrates a disc-type brake system incorporating an actuator in the form of a master cylinder assembly 10 which includes the pressure relief valve arrangement of the present invention. In accordance with conventional construction of a brake system of this type, master cylinder assembly 10 is interconnected with an operator-controlled actuating lever shown at 12, and functions to control movement of a caliper shown schematically at 14. Caliper 14 closes upon brake application to apply pressure to a brake disc or rotor 16, and opens upon release to relieve pressure on rotor 16. Master cylinder assembly 10 is particularly well suited for use in a fixed caliper or hard-mounted (vs. floating automotive type) application, such as is commonly incorporated in a vehicle such as a motorcycle, snowmobile or all terrain vehicle (ATV), although it is understood that master cylinder assembly 10 may be used in other types of braking arrangements.

Master cylinder assembly 10 includes a body 18 that defines a passage 20 within which a piston 22 is mounted. Master cylinder body 18 further includes a fluid reservoir 24 sealed by a cap 26 which includes a diaphragm 28, in a known manner. Reservoir 24 is defined by side walls such as shown at 30 and a bottom wall 32, a portion of which defines passage 20.

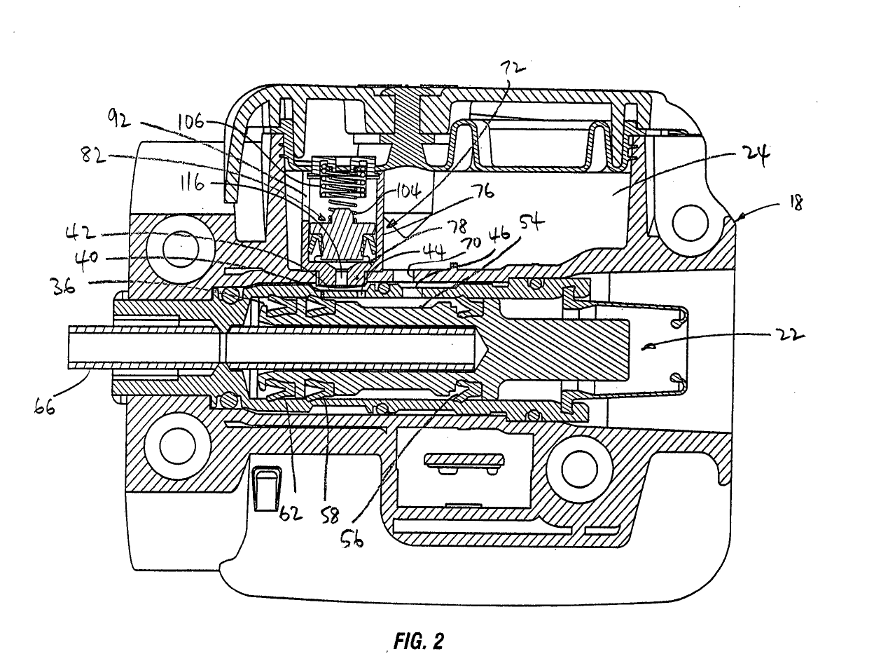

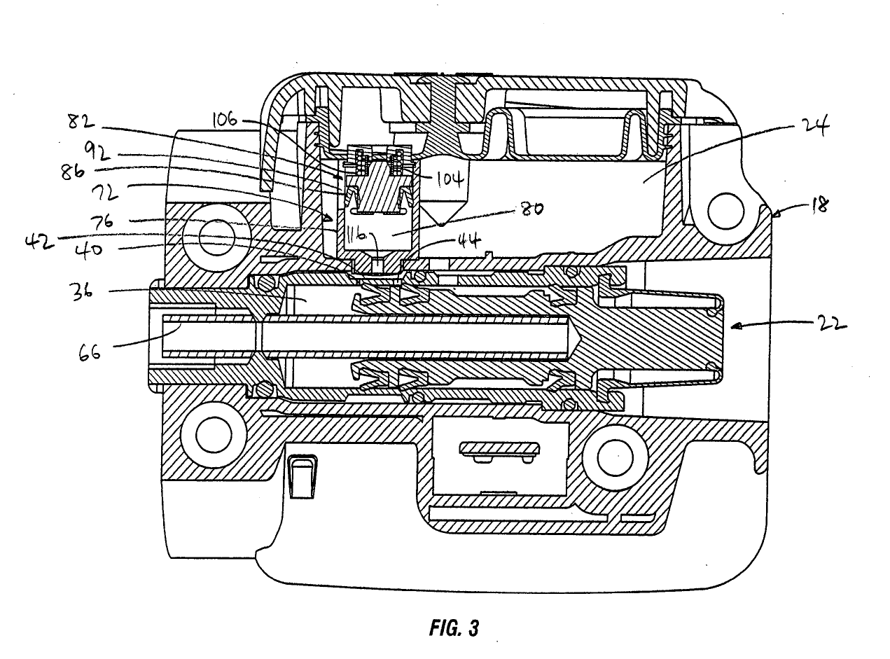

In accordance with known construction, piston 22 is reciprocally movable within a cartridge 34 located within passage 20, between a retracted position as shown in FIGS. 1 and 3 in which brake caliper 14 is released, and an extended position as shown in FIG. 2 in which brake caliper 14 is applied.

Cartridge 34 includes a passage 36 defined by an annular cartridge side wall 38, and piston 22 is movably mounted within passage 36. A timing port 40 is formed in cartridge side wall 38, and establishes communication between cartridge passage 36 and a recess 42 formed in the outer surface of cartridge side wall 38. In addition, a backup port 44 is formed in cartridge side wall 38 at a location spaced from timing port 40, and establishes communication between cartridge passage 36 and recess 42. Cartridge 34 further includes a reservoir port 46 that communicates between cartridge passage 36 and a recess 48 formed in the outer surface of cartridge side wall 38. An O-ring seal 50 is seated within a groove formed in cartridge side wall 38 between recesses 42 and 48, and engages the inwardly facing surface of cartridge side wall 38 to establish a fluid-tight seal therebetween.

Piston 22 includes a spool section 52 having a recess 54 located between a pair of cup-type seals 56, 58 that contact the inwardly facing surface of cartridge side wall 38 to establish a fluid-tight seal therebetween. In addition, piston 22 includes a forward extension section 60 that extends from spool section 52. A cup-type seal 62 is mounted to extension section 60, and engages the inwardly facing surface of cartridge side wall 38 to form a fluid-tight seal therebetween.

Piston 22 defines a passage 64 within which a return spring 66 is mounted. The forward end of return spring 66 is supported by a collar 68, in accordance with known construction. Return spring 66 is operable to bias piston 22 toward the retracted position, in a manner as known in the art.

Bottom wall 32 of master cylinder body 18, which forms a part of fluid reservoir 24, is formed with a return opening 64 that communicates between fluid reservoir 24 and master cylinder passage 20. Forwardly of return opening 64, a pressure relief valve assembly 66 is mounted to bottom wall 32. In a manner to be explained, pressure relief valve assembly 66 is operable to control fluid flow into and out of reservoir 24, and to relieve excessive pressure that may be experienced in the pressure vessel or chamber located in the forward portion of cartridge passage 36 forwardly of piston seal 62.

Pressure relief valve assembly 72 includes a valve body or cylinder 74 having a side wall 76 and an end wall 78 that cooperate to define an internal cavity 80. A valve member 82 is movably mounted within internal cavity 80. Valve member 82 includes a body section 84 that carries a cup-type seal 86 which contacts the inner surface of side wall 76 to form a fluid-tight seal therebetween. Valve member 82 further includes a shoulder section 88 which is configured to maintain seal 86 in position, and a head section 90 that extends from shoulder section 88.

Side wall 76 of pressure relief valve cylinder 74 is formed with a valve relief opening or port 92, and seal 86 is normally engaged with the area of cylinder side wall 76 below the lowermost extent of relief port 92.

A cap 94 is secured to the upper end of valve cylinder 74. Cap 94 includes an outwardly extending flange 96 engaged within a groove 98 formed in the inner surface of side wall 76, which functions to mount cap 94 to valve cylinder 74.

Cap 94 is formed with a recess 100 in its inner surface, which faces and is in communication with internal cavity 80 of valve cylinder 74. Recess 100 is formed to define an inner mounting boss 102, and one end of a low-force inner spring 104 is engaged with mounting boss 102. The opposite end of low-force inner spring 104 is engaged with head section 90 of valve member 82. Inner spring 104 is operable to apply a biasing force on valve member 82 that tends to urge valve member 72 toward end wall 78 of valve cylinder 74.

An outer, high force preloaded spring 106 is seated within cap recess 100 outwardly of mounting boss 102. The lowermost extent of outer spring 106, shown at 108, is provided with an elongated configuration, and the ends of lower turn 108 of outer spring 106 are engaged with opposed seat surfaces 110 which are formed in the inner surface of valve cylinder side wall 76. With this construction, outer spring 106 is preloaded when cap 94 is engaged with valve cylinder 74, via seating of the lower turns 108 of outer spring 106 in seat surfaces 110 and compression that is applied to outer spring 106 when cap 94 is secured to valve cylinder 74.

Valve cylinder 74 is mounted within reservoir 24 via an extension 112 of end wall 78 that is received within an opening 114 formed in bottom wall 32. Representatively, a threaded connection may be provided between extension 112 and opening 114, although it is understood that any other satisfactory mounting arrangement may be employed. A passage 116, which includes a frustoconical inlet, is formed in end wall 78 and extension 112, and establishes communication between internal cavity 80 of valve cylinder 74 and recess 42 defined by cartridge 34.

FIG. 1A is an exploded view of the pressure relief valve arrangement 200 in accordance with one aspect of the present invention. The valve arrangement 200 includes a valve body 202, a piston 204, and a generally u-shaped cup seal 206, with these items defining a pressure vessel 208. The valve arrangement further includes a cap 210, a small, low installed force, spring 212 and a larger, higher installed force spring 214.

In one embodiment, a pressure relief valve assembly and a master cylinder combination is disclosed. On such master cylinder for use in the combination is the master cylinder shown and described with respect to FIGS. 1-3. The combination comprises: a master cylinder having a master cylinder reservoir; and a pressure relief valve assembly positioned within the master cylinder reservoir. The pressure relief valve assembly itself comprises: a pressure vessel for displacing a fluid. The pressure vessel itself comprises: a valve body; a generally u-shaped cup seal disposed adjacent the valve body; and a piston in sealing contact with the generally u-shaped cup seal. The valve arrangement further comprises: a first spring located adjacent the pressure vessel piston; a second spring adjacent the pressure vessel piston and concentric with the first spring; and a cap in engagement with the first spring. The second spring is preloaded to have a higher installed force and a higher spring rate than the first spring. When the piston moves to contact the first spring, compress the first spring, and compress the second spring, fluid is drawn into the pressure vessel, thereby relieving pressure from the master cylinder reservoir.

A method of reducing caliper piston knockback using a brake master cylinder is also disclosed. The method comprises: displacing a pressure relief valve assembly piston to contact and compress a first spring and a second spring concentric with the first spring, thereby increasing the pressure required to force caliper pistons into their respective bores, thereby reducing caliper piston knockback.

During every braking event the system stabilizes itself when the valve discharges all its fluid on a brake application. The valve is designed to release pressure before caliper pistons can be actuated due to thermal expansion of the fluid.

In operation, valve member 82 is normally in an expanded position as shown in FIG. 1 when the brake is released and piston 22 is in the retracted position. The brake is applied by operating brake actuating lever 12 in a known manner, to move piston 22 from the retracted position of FIG. 1 to the extended position of FIG. 2. Such movement of piston 22 displaces a quantity of fluid from the pressure chamber of cartridge passage 36 outwardly to brake caliper 14, to apply pressure on brake disc 16 in a known manner. Such movement of piston 22 to the extended position functions to cut off communication of timing port 40 with the pressure chamber of cartridge passage 36, and also positions the rearward cup seal 58 forwardly of both timing port 40 and backup port 44.

During such movement of piston 22 to the extended position, internal cavity 80 of valve cylinder 74 is open to reservoir 24 via passage 116, backup port 44, spool recess 54, reservoir port 46, cartridge recess 48 and return opening 70. Such communication between valve cylinder internal cavity 80 and reservoir 24 allows valve member 82 to be moved under the influence of inner spring 104 from its expanded position of FIG. 1 to its exhaust position of FIG. 2, to discharge fluid from valve cylinder internal cavity 80. When the operator releases actuating lever 12, piston 22 returns to the retracted position of FIG. 1 under the influence of retraction spring 66, which causes introduction of a volume of fluid into the pressure chamber of cartridge passage 36 and movement of cartridge seals 58, 62 to the position as shown in FIGS. 1 and 3, in which timing port 40 is opened to the pressure chamber of cartridge passage 36 and backup port 44 is sealed. In this manner, fluid that is introduced to cartridge passage 36 upon retraction of piston 22 is supplied through timing port 40 to cartridge recess 42, and through passage 116 of valve cylinder 74 into internal cavity 80. The fluid pressure is sufficient to cause valve member 82 to return to the expanded position of FIG. 1, against the bias of inner spring 104.

In the event brake disc 16 contacts the brake pads of caliper 14 during rotation of brake disc 16, which presents the potential for knock-back of piston 22, an increase in fluid pressure is experienced in the pressure chamber of cartridge passage 36. The pressure increase is transferred through timing port 40 and cartridge recess 42 into valve cylinder internal cavity 80 through passage 116, to engage valve member 82 with the lower end of outer spring 106. If the increase in pressure is above a predetermined threshold at which knock-back normally occurs, as governed by the preload on outer spring 106, the increased pressure is operable to force valve member 82 upwardly against the bias of outer spring 106, as shown in FIG. 3, to a relief position in which the lip of valve seal 86 is located above the lowermost extent of relief port 92. Such movement of valve member 82 functions to establish communication between valve internal cavity 80 and reservoir 24 through relief port 92. In this manner, the fluid pressure in the pressure chamber of cartridge passage 36 is relieved. When pressure in the pressure chamber of cartridge passage 36 falls below the threshold established by the force of outer spring 106, valve member 82 is returned to the expanded position as shown in FIGS. 1 and 3 under the influence of both inner spring 104 and outer spring 106.

Valve member 82 can also be moved to the relief position of FIG. 3 when pressure in the pressure chamber of cartridge passage 36 increases above the predetermined threshold for any other reason, e.g. as a result of thermal expansion of the brake fluid which otherwise may result in drag of the pads of caliper 14 on brake disc 16.

Generally, when the system is first assembled its “at rest” assembled state is where the piston is fully extended within the valve. The “at rest” operational state (i.e., when the system is attached to the vehicle) is with the piston compressing the small spring but not contacting the large spring.

During a braking event, the valve works in the following manner (assuming the valve starts from its “at rest” position on vehicle): When the brake lever/pedal is actuated, the master cylinder piston and primary cup travel forward, thereby closing off the port timing hole and creating pressure in the brake caliper. At the same time, fluid in the valve is directed into the master cylinder reservoir through the backup port, over the primary backup cup, and through the reservoir port. When the brake is released, fluid travels over the primary cups (the amount dependant upon return velocity) and the master cylinder piston stops at its home position. With both cups behind their respective ports, the last event is the retraction of the caliper pistons into their bores. When this occurs, the fluid displaced in the caliper pushes the piston in the valve back to its home (at rest) position. The retraction of the caliper pistons is the last event in the braking sequence.

This occurs every braking event. It is important that the valve be able to fully discharge during a braking event, otherwise the valve will pump up until the valve piston hits the large spring, which eliminates the calipers ability to retract the pistons and will cause the brake pads to drag.

During a knock back event, the valve works in the following manner: the caliper piston experiences an external force wanting to push it into its respective bore. The valve piston moves slightly contacting the large preloaded spring. Due to the increased pressure needed to move the valve piston further against the spring, the force needed to push the piston into the bore is increased. If the force is great enough, with enough displacement to overcome the large spring force in the valve, the valve can dump this pressure to the master cylinder reservoir as the valve U-cup pass this port. This pressure relief is also used in thermal expansion of the liquid.

While the invention has been shown and described with respect to a specific embodiment, it is understood that various alternatives and modifications are contemplated as being within the scope of the invention. For example, and without limitation, while valve cylinder 74 is illustrated as being a separate member that is mounted to the valve body, it is also understood that the valve cylinder may be formed integrally with the material of the master cylinder body during manufacture. Moreover, it is important to note that the placement of the valve body and associated valve arrangement components described herein are shown in a particular region of the master cylinder shown and described. However, it is contemplated that the location or placement of the arrangement can vary depending on a number of constraints, for example, the size and dimension (and in general the make and model) of the master cylinder utilized. Thus, the changes in the exact location of the valve arrangement are contemplated, provided that the fluid flow and pressure relief objectives are met. The preferred location disclosed herein is chosen for its ability to be easily bled with the system (versus separately) and to provide a direct path for the fluid to be dumped from the valve into the master cylinder reservoir, reducing the need for extra lines and to reduce overall complexity.

Various alternatives and embodiments are contemplated as being within the scope of the following claims particularly pointing out and distinctly claiming the subject matter regarded as the invention.

What is claimed is:

1. A brake actuator for a disk brake system having a brake disk and a caliper, comprising:
a master cylinder body defining a fluid reservoir;
a piston mounted to the master cylinder body, wherein the piston is movable relative to the master cylinder body between an extended position and a retracted position, wherein the piston and the master cylinder body are configured such that movement of the piston to the extended position displaces a quantity of fluid to operate the caliper in a first direction, and movement of the piston toward the retracted position returns a quantity of fluid toward the fluid reservoir through a pressurized fluid flow path defined by the piston and the master cylinder body; and
a pressure relief valve arrangement interposed between the fluid flow path and the reservoir for controlling the flow of fluid to the reservoir upon movement of the piston between the extended and retracted positions, wherein the pressure relief valve arrangement is configured and arranged to selectively vent fluid from the fluid flow path to the fluid reservoir in the event pressure in the fluid flow path exceeds a predetermined threshold.

2. The brake actuator of claim 1, wherein the pressure relief valve arrangement includes a valve body defining an internal cavity in communication with the fluid flow path, wherein the valve body includes a relief port in communication with the fluid reservoir.

3. The brake actuator of claim 2 further comprising a biased valve member movably mounted within the internal cavity, wherein the valve member is movable to an expanded position against the bias to accommodate introduction of fluid from the fluid flow path into the internal cavity upon movement of the piston toward the retracted position, and to an at rest position under the influence of the bias to discharge fluid from the internal cavity to the fluid reservoir through a discharge port associated with the master cylinder body upon movement of the piston toward the extended position.

4. The brake actuator of claim 3 wherein the valve member in the expanded and at rest positions prevents communication between the internal cavity and the fluid reservoir through the relief port.

5. The brake actuator of claim 5 wherein the valve member is further movable from the expanded position to a relief position against the bias when the pressure in the fluid flow path exceeds the predetermined threshold to enable fluid to flow from the internal cavity to the fluid reservoir through the relief port, to relieve the fluid pressure in the fluid flow path.

6. The brake actuator of claim 2 wherein a fluid tight seal is established between and among the internal cavity, the master cylinder reservoir, and a master cylinder cartridge passage.

7. The brake actuator of claim 1 wherein the master cylinder includes a timing port for establishing communication between a master cylinder cartridge passage and an internal cavity defined by a pressure relief valve arrangement valve body.

8. The brake actuator of claim 1 wherein the master cylinder includes a backup port for establishing communication between a cartridge passage and an internal cavity defined by a pressure relief valve arrangement valve body.

9. A method of relieving fluid pressure exceeding a predetermined threshold in a fluid flow path associated with a disk brake system having a master cylinder including a body and an extendible and retractable piston, wherein the master cylinder body includes a fluid reservoir, comprising the step of selectively establishing fluid communication between the fluid flow path and the fluid reservoir when the fluid pressure in the fluid flow path exceeds the predetermined threshold to alleviate adverse effects on the brake system resulting from excessive pressure in the fluid flow path.

10. The method of claim 6, wherein the step of selectively establishing fluid communication between the fluid flow path and the fluid reservoir is carried out via a pressure relief valve arrangement interposed between the fluid flow path and the fluid reservoir, wherein the valve arrangement includes an internal cavity in communication with both the fluid flow path and the fluid reservoir, and a movable biased valve member disposed within the internal cavity that is operable to control the flow of fluid between the internal cavity and the fluid reservoir.

11. The brake actuator of claim 1, wherein the pressure relief valve equalizes pressure in the master cylinder so as to reduce a knockback condition.

12. The brake actuator of claim 1 wherein the valve body is capable of being bled integrally with the master cylinder reservoir.

13. The brake actuator of claim 1 wherein the valve body has a direct fluid communication path with the master cylinder reservoir.

14. The brake actuator of claim 1 wherein the arrangement includes a major bias member and minor bias member and wherein the arrangement has an assembled at rest state wherein the valve piston compresses the minor bias member and does not compress the major bias member.

15. The brake actuator of claim 1 further comprising a cap which is secured to an upper end of the valve cylinder.

16. A pressure relief valve assembly in combination with a master cylinder, the combination comprising:
a master cylinder having a master cylinder reservoir; and
a pressure relief valve assembly positioned within the master cylinder reservoir, the assembly comprising:
a pressure vessel for displacing a fluid, the pressure vessel comprising:
a valve body;
a generally u-shaped cup seal disposed adjacent the valve body; and
a piston in sealing contact with the generally u-shaped cup seal;
a first spring located adjacent the pressure vessel piston;
a second spring adjacent the pressure vessel piston and concentric with the first spring; and
a cap in engagement with the first spring;
wherein the second spring is preloaded to have a higher installed force and a higher spring rate than the first spring.

17. The pressure relief valve assembly and master cylinder combination of claim 13 wherein, when the piston moves to contact the first spring, compress the first spring, and compress the second spring, fluid is drawn into the pressure vessel, thereby relieving a knockback pressure from the master cylinder reservoir.

18. A method of reducing caliper piston knockback using a brake master cylinder, the method comprising: displacing a pressure relief valve assembly piston to contact and compress a first spring and a second spring concentric with the first spring, thereby drawing a fluid into a pressure vessel; and
transferring the fluid from the pressure vessel to a reservoir located within the master cylinder, thereby reducing caliper piston knockback.
